(19) United States
(12) Patent Application Publication
(10) Pub. No.: US 2026/0095721 A1
(43) Pub. Date: Apr. 2, 2026

(54) CONTEXT-AWARE LOCATION AND ACTIVITY PREDICTION FOR SMARTPHONE USERS

(71) Applicant: Samsung Electronics Co., Ltd., Suwon-si (KR)

(72) Inventors: Khuong N. Nguyen, Frisco, TX (US); Hoang Viet Nguyen, Frisco, TX (US); Yuming Zhu, Plano, TX (US); Rebal Al Jurdi, Allen, TX (US)

(21) Appl. No.: 19/337,865

(22) Filed: Sep. 23, 2025

Related U.S. Application Data
(60) Provisional application No. 63/701,145, filed on Sep. 30, 2024.

(51) Int. Cl. H04W 4/021

(52) U.S. Cl. CPC H04W 4/021

(57) ABSTRACT

A method for deploying context-aware location and activity prediction for smartphone users includes receiving information associated with a device that is associated with a user. The method includes combining the information and a neural model personalized for the user. The method include determining one or more predictions of one or more probable future contexts for the user based on the combined information and the neural model. The one or more probable future contexts including at least one of: a spatial context, a temporal context, or a behavioral context.

### CROSS-REFERENCE TO RELATED APPLICATIONS

This application is based on and claims priority under 35 U.S.C. § 119 to U.S. Provisional Patent Application No. 63/701,145 filed on Sep. 30, 2024, which is incorporated by reference herein in its entirety.

### TECHNICAL FIELD

This disclosure relates generally to wireless communication devices. More specifically, this disclosure relates context-aware location and activity prediction for smartphone users.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides context-aware location and activity prediction for smartphone users.

In one embodiment, a method for deploying context-aware location and activity prediction for smartphone users. The method includes receiving information associated with a device that is associated with a user. The method includes combining the information and a neural model personalized for the user. The method include determining one or more predictions of one or more probable future contexts for the user based on the combined information and the neural model. The one or more probable future contexts including at least one of: a spatial context, a temporal context, or a behavioral context.

In another embodiment, an electronic device for deploying context-aware location and activity prediction for smartphone users. The electronic device includes at least one processor configured to receive information associated with an electronic device that is associated with a user. The processor(s) is configured to combine the information and a neural model personalized for the user. The processor(s) is configured to determine one or more predictions of one or more probable future contexts for the user based on the combined information and the neural model. The one or more probable future contexts including at least one of: a spatial context, a temporal context, or a behavioral context.

In yet another embodiment, a non-transitory computer readable medium embodying a computer program for deploying context-aware location and activity prediction for smartphone users is provided. The computer program comprises program code that, when executed by a processor of an electronic device, causes the electronic device to receive information associated with the electronic device that is associated with a user. The program code, when executed, causes the electronic device to combine the information and a neural model personalized for the user. The program code, when executed, causes the electronic device to determine one or more predictions of one or more probable future contexts for the user based on the combined information and the neural model. The one or more probable future contexts including at least one of: a spatial context, a temporal context, or a behavioral context.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIG. 2 illustrates an example gNodeB (gNB) according to this disclosure;

FIG. 3 illustrates an example user equipment (UE) according to this disclosure;

FIG. 4 illustrates a system for implementing context-aware location and activity prediction for smartphone users, according to embodiments of this disclosure;

FIG. 5 illustrates a system architecture of a forecast engine, according to embodiments of this disclosure;

FIG. 6 illustrates a raw data aggregator (RDA), according to embodiments of this disclosure;

FIG. 7 illustrates an input processor (input processor), according to embodiments of this disclosure;

FIG. 8 illustrates a neural central forecasting unit (NCFU), according to embodiments of this disclosure;

FIG. 9 illustrates a post processor, according to embodiments of this disclosure;

FIG. 10 illustrates a process for triggering a re-learning of an AI model, according to embodiments of this disclosure;

FIG. 11 illustrates a process of generating raw predictions of probable future contexts for the user using an AI model that is implemented using transformer architecture, according to embodiments of this disclosure;

FIG. 12 illustrates a process for determining a number of home-bases for the NCFU 800, according to embodiments of this disclosure;

FIG. 13 illustrates a method for context-aware location and activity prediction for smartphone users, according to embodiments of this disclosure; and

FIG. 14 illustrates a method for partitioning the encoded integrated logging data into at least one of training sets and evaluation sets, according to embodiments of this disclosure.

### DETAILED DESCRIPTION

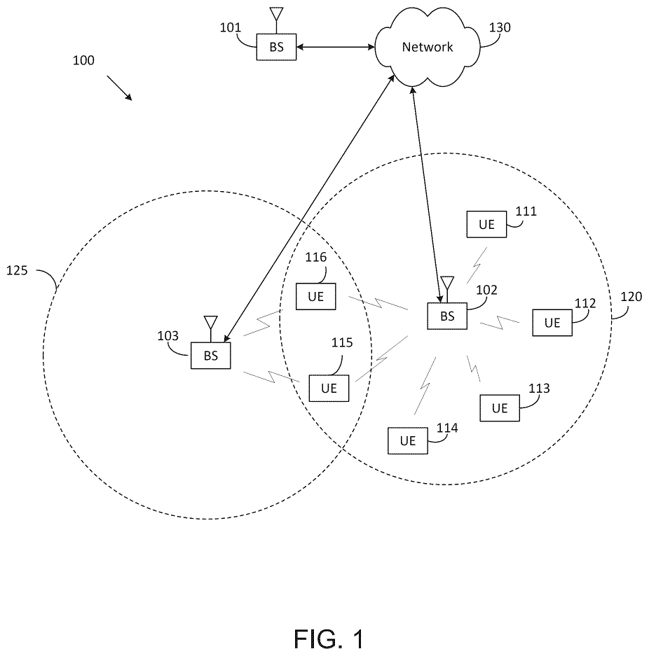

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Next location and activity prediction is an emerging category of valuable smartphone services/applications that have gained popularity lately due to the vast amount of sensor data gathered from users' smartphones. The likelihood of a user's next destination or the subsequent action performed on their device is closely associated with the historical context sensor information collected on the device. Predicting next contexts, whether spatial (such as location) or behavioral (such as activity), is a growing smartphone service category driven by abundant sensor data. Rules-based methods that use rules to predict next contexts do not use or overlook individual user patterns.

In this disclosure, a prediction of user's next destination or action may be strongly influenced by historical sensor data on their device, making the pattern highly personalized to the individual user. This disclosure provides approaches to leverage the background sensor information recorded during a user's daily routine, along with the user's visited locations and device actions, to construct a prediction model capable of determining the probable next locations and/or activities for the user. This disclosure provides Context Forecast Engine (CFE), which is a sophisticated system that gathers and processes multi-modal historical data, enabling it to learn and precisely predict the specific user's upcoming contexts, such as locations and activities, directly on the device. These capabilities can be beneficial for various applications and services, including recommending suitable apps based on user habits and delivering relevant and informative content related to the upcoming location.

This disclosure provides a system that learns smartphone user patterns and user behaviors to predict location and activities and solve a variety of problems related to personalization, efficiency, and security. Some of the potential problems that embodiments of this disclosure address are: (1) Contextual Awareness; (2) Resource Optimization; (3) User Experience Enhancement; (4) Security & Privacy; and (5) Traffic Congestion and Routing. Regarding contextual awareness, many services fail to fully understand a user's context. As a solution, embodiments of this disclosure provide predicting location and activities to enable services to be more intelligent and responsive. Regarding resource optimization, smartphones often perform background tasks without considering the user's current activity or current location, which may lead to inefficient use of resources such as battery power and processing power. Regarding user experience enhancement, some apps may often require users to manually input preferences or take actions to trigger functionality. As a solution, embodiments of this disclosure provide predicting behavior to enable seamless automation. Regarding security and privacy, embodiments of this disclosure learn and understand typical user behaviors to detect anomalous patterns that might indicate fraud or other malicious activities. Regarding traffic congestion and routing, embodiments of this disclosure provide predicting future location patterns to help optimize traffic flow and improve transportation systems.

In some approaches, the prediction models used are primarily rule-based, failing to provide personalized experiences tailored to individual users. However, with recent advancements in artificial intelligence (AI), now there is a capability to develop prediction models that can adapt to changes in user routines. The AI-based models in this disclosure are capable of handling variations in user behavior, such as during periods of vacation or work relocation, ensuring accurate predictions even under these circumstances. Moreover, the AI-based models in this disclosure incorporate mechanisms to detect and correct any drifts or biases that may occur in user routines over time, providing reliable and up-to-date predictions. By leveraging these features, the embodiments in this disclosure can create highly customized and effective solution for users.

This disclosure presents systems and methods that utilize historical user data to forecast smartphone users' locations, activities, and the corresponding timestamps. To achieve this, the embodiments of this disclosure provide systems and methods that collect users' multi-modal data and processes it accordingly. By utilizing the processed data, an AI system deployed on the device (for example, smartphone) continuously learns this data directly on the smartphone device to accurately predict the user's likely next locations/activities in the near future.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, the wireless network 100 supports deploying context-aware location and activity prediction for smartphone users.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

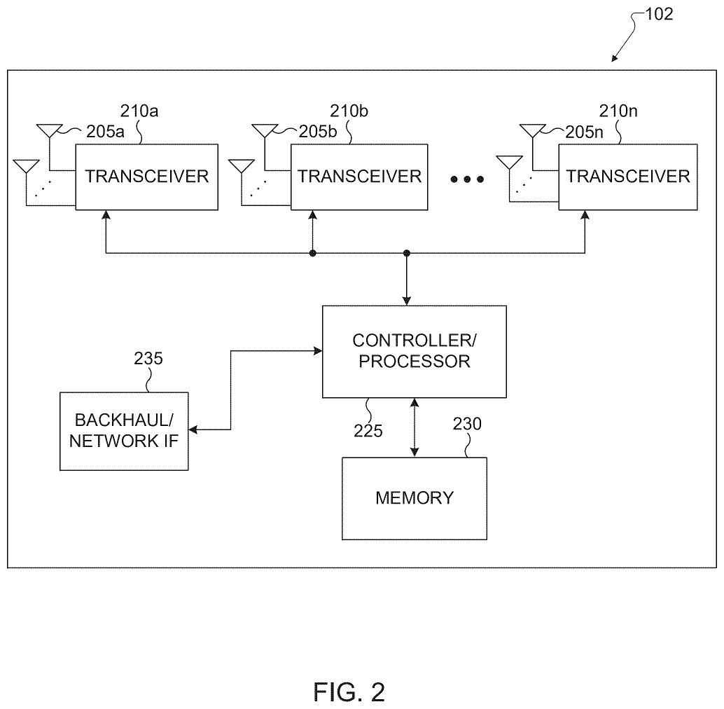

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

As described in more detail below, the gNB 102 is configured for deploying context-aware location and activity prediction for smartphone users.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

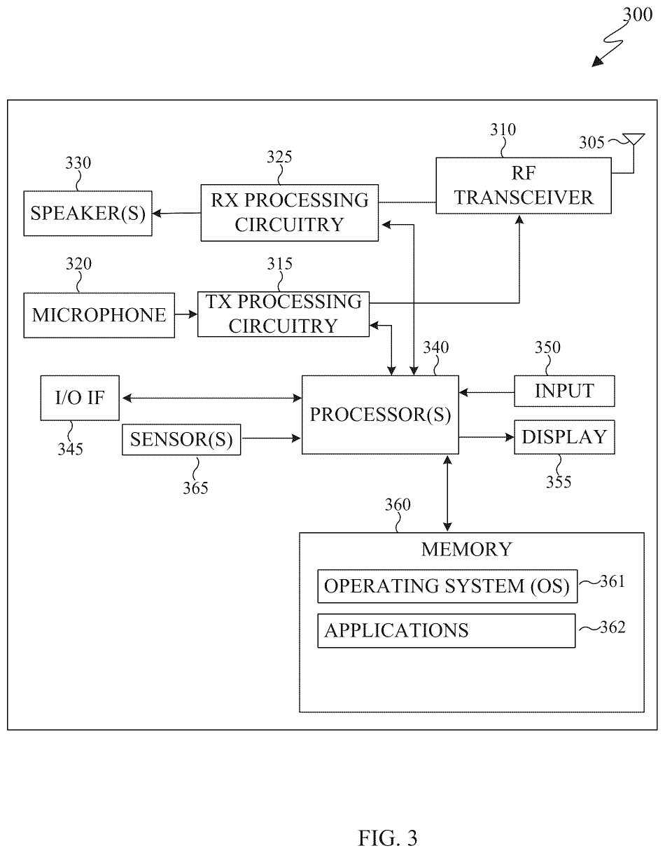

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

As described in more detail below, the UE 116 is configured for deploying context-aware location and activity prediction for smartphone users.

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

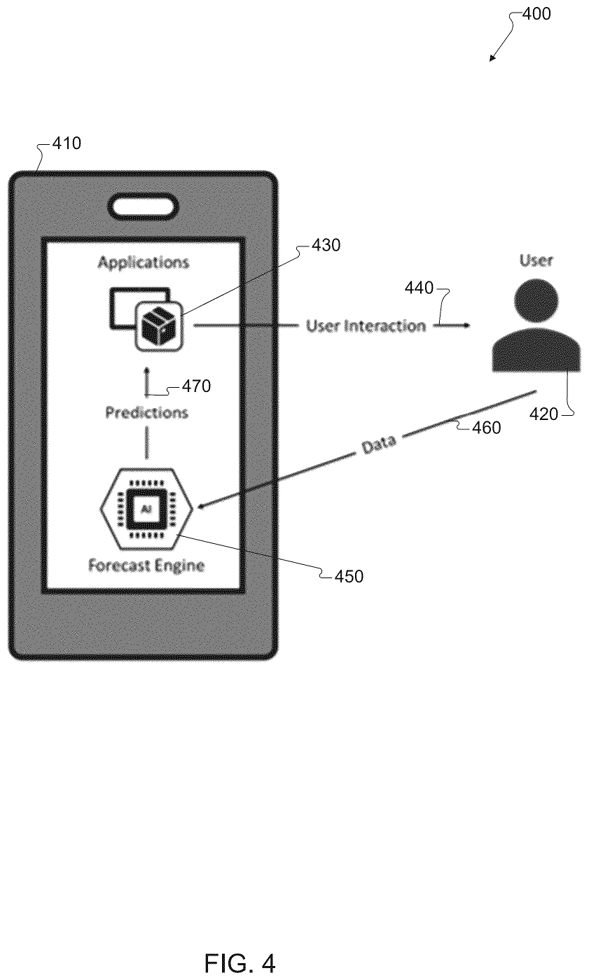

FIG. 4 illustrates a system 400 for implementing context-aware location and activity prediction for smartphone users, according to embodiments of this disclosure. The embodiment of the system 400 for shown in FIG. 4 is for illustration only, and other embodiments could be used without departing from the scope of this disclosure.

The system 400 can be implemented within an electronic device that is associated with a user 420, such as a smartphone 410. To associate the user 420 with the smartphone 410, the user 420 can be the owner of the smartphone 410, or the smartphone 410 can generate and store a user profile for the user 420 when the user 420 registers oneself with the smartphone 410. The smartphone 410 and its applications 430 can be the UE 116 and applications 362 of FIG. 3, respectively. The user interactions 440 show that applications 430 interact with the user 420, for example, providing user interfaces that enable the application 430 to receive user input, outputting responses to user inquiries or prompts or recommendations to the user 420.

The system 400 includes a forecast engine 450, which includes an artificial intelligence (AI) model that processes data 460 that the forecast engine 450 receives from the user 420. The forecast engine 450 uses historical user data to forecast the smartphone user's 420 locations and activities, and to forecast the timestamps corresponding to the forecasted locations and activities of the user. To achieve this, forecast engine 450 collects the users' multi-modal data and processes it accordingly. By using the processed data, an AI system deployed on the device (smartphone 410) continuously learns this data directly on the device to accurately predict the user's 420 likely next locations and next activities in the near future. The forecast engine 450 outputs one or more predictions 470 to the applications 430.

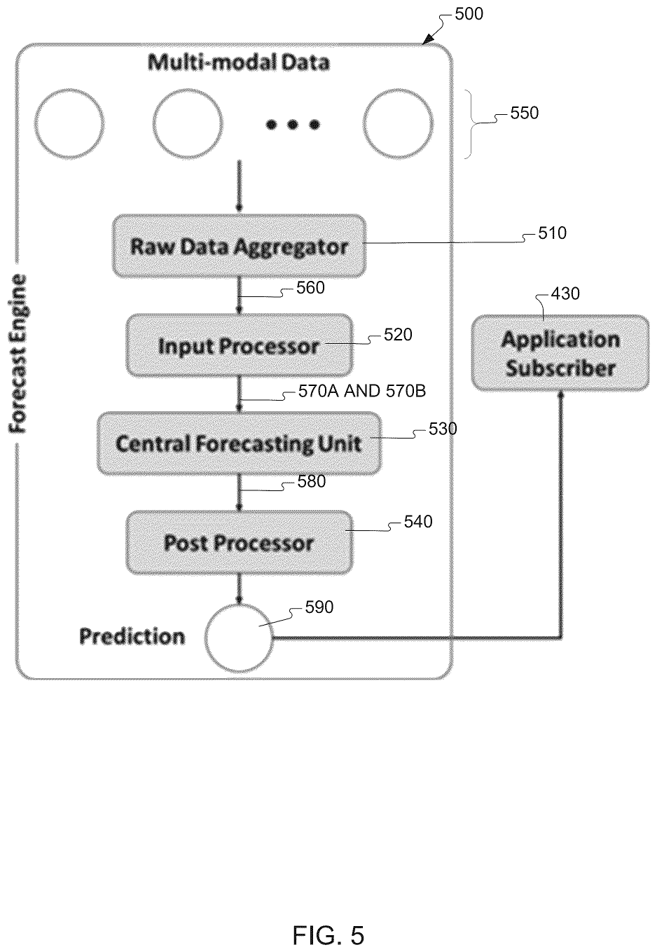

FIG. 5 illustrates a system architecture of a forecast engine 500, according to embodiments of this disclosure. The embodiment of the forecast engine 500 shown in FIG. 5 is for illustration only, and other embodiments could be used without departing from the scope of this disclosure. The forecast engine 500 can be the same as or similar to the forecast engine 450 of FIG. 4.

The forecast engine 500 performs location prediction, which relies on a combination of sensors and data, such as GPS, Wi-Fi, and cell tower triangulation. To define locations meaningfully, the forecast engine 500 categorizes specific locations and categorizes types of locations. Home, workplace, frequently-visited place, and transit location are examples of types of locations. The user's home can be identified by detecting where the smartphone spends the most time overnight, for example, based on GPS data patterns or Wi-Fi patterns. Geofencing techniques can help define a user's home region more precisely. The user's workplace can be identified as a location where the user spends most of one's weekdays during regular working hours. There can be more than one frequently-visited place for the user, such as gyms, parks, coffee shops, etc. Each frequently-visited place is identified based on regular visit patterns of the user, for example, based on GPS data patterns. Locations such as bus stops, train stations, or airports can be identified by tracking when the user is at or moving between different public transport hubs. When performing location prediction, the forecast engine 500 determines and outputs a probable future spatial context, which can be a specific position on Earth (i.e., geographical location) and its corresponding categorized type of location.

The forecast engine 500 performs activity prediction that is determining and outputting a probable future behavior context, which can be a category of activity. Activities can be defined based on how the user interacts with one's phone, the user's movement patterns, sensor data, and external triggers. Activities generally involve three key aspects: environmental context, device usage patterns, and social context. Environmental context includes factors such as the user's current location, time of day, weather, and the presence of nearby devices or people. Device usage patterns include which apps the user interacts with, how the user interacts with each app, notifications, and other usage data. Social context includes the presence of other people (e.g., detecting proximity via Bluetooth) or interaction through messaging apps or social apps.

There are multiple categories of activities that forecast engine 500 can determine, including but not limited to: working, commuting, exercising, shopping, eating/drinking, and leisure/socializing. The forecast engine 500 can infer or determine that a user is working based on the user's location and the time of day, for example, user's current location is at the user's workplace or at user's office while the current time of day is the user's regular working hours. The forecast engine 500 can infer or determine that a user is working based on phone usage patterns, for example, frequent usage of email app or calendar app. The forecast engine 500 can infer or determine that a user is commuting based on not only movement patterns (e.g., traveling between home and workplace) but also by contextual data like the time of day, frequent use of public transport apps, or listening to music or podcasts during travel. The forecast engine 500 can define exercise activities and can determine that a user is exercising based on the user's movement data from sensors in combination with the user's location indicating a visit to a location known as a gym or fitness area. The forecast engine 500 can determine that a user is shopping based on geofencing data that indicates entering a store or shopping mall can trigger the shopping activity classification, especially when the user interacts with retail apps or payment systems while located within the geofencing boundary of the store of shopping mall. The forecast engine 500 can determine that a user's activity is eating/drinking based on the user's location corresponding to visiting a restaurant or café at typical meal times, or using food delivery apps. The forecast engine 500 can infer or determine that the user is engaged in socializing or leisure activity based on social contextual data that detected (via Bluetooth or Wi-Fi) nearby other users in combination with the user's current location at a park, restaurant, or social venue.

The system architecture of the forecast engine 500 includes a raw data aggregator (RDA) 510, an input processor 520, a central forecasting unit 530, and a post processor 540. The system architecture of the forecast engine 500 can be a pipeline that includes a sequence of functions that: (i) record sensor data from user smartphones actions during a user's daily routine; (ii) process the aggregated raw data to convert it into an appropriate format; (iii) determine the next probable contexts and their associated timestamps using the processed input; and (iv) validate the prediction of the next probable contexts and their associated timestamps and finalize the output.

The system architecture of the forecast engine 500 receives multi-modal data 550 as input to the RDA 510, and the multi-modal data 550 is information associated with a device that is associated with a user (such as the smartphone 410 associated with the user 420 of FIG. 4). The multi-modal data 550 can include raw sensor data generated by the sensors 365 of FIG. 3, the data 460 of FIG. 4.

The raw data aggregator 510 collects user data from various sources, and this data includes raw spatial, temporal, and activity information. The RDA 510 is a hybrid logging mechanism that integrates interval-based logging for capturing continuous, time-interval data and event-based logging for recording discrete, event-triggered data, ensuring comprehensive and versatile data collection. The RDA 510 outputs integrated logging data 560.

The input processor 520 receives integrated logging data 560 as input from the RDA 510. The input processor 520 retrieves data from the RDA's 510 data repository and processes it into a suitable format for input to the central forecasting unit 530. More particularly, the input processor 520 converts the raw integrated logging data 560 into a format of inference input 570A and into a format of learning input 570B. In addition to processing the integrated logging data 560, input processor 520 maintains a memory buffer containing the processed data for immediate inferences and includes mechanisms to handle training and testing data for inputting into the central forecasting unit 530.

The central forecasting unit 530 is a core component of the forecast engine 500, as such, central forecasting unit 530 includes the AI model that processes the multi-modal data that the forecast engine 500 receives. The central forecasting unit 530 receives the processed data from the input processor 520, and learns the user's historical patterns (locations and activities) based on this data received from the input processor. By analyzing these patterns, central forecasting unit 530 predicts future events.

To improve accuracy of forecasting future contexts and their associated timeframes, the central forecasting unit 530 is a neural forecast unit that employs deep learning for multi-task learning, context classification, and time estimation. The central forecasting unit 530 generates one or more predictions 580 of probable future contexts for the user. The one or more predictions 580 are also referred to as raw predictions.

The post processor 540 receives the predictions 580 generated by the central forecasting unit 530 and incorporates additional available information to produce the final prediction that this disclosure refers to as a final decision 590. The post processor 540 is a symbolic post processor designed to refine the raw predictions 580 by using historical predictions, ground truth data stored in a dedicated repository, and logical and ruled-based constraints to compute a probability value, thereby effectively quantifying the reliability of the current raw predictions 580. Based on the probability value quantifying the reliability of the current raw predictions 580, the post processor 540 validates the one or more current raw predictions 580. The post processor 540 determines whether to output one or more validated predictions as the final decision 590.

The system architecture of the forecast engine 500 outputs the final decision 590 to one or more applications 430 that are application subscribers. For example, the forecast engine 500 can provide a future-context forecasting service to its subscribers, namely, the applications 430. The future-context forecasting service enables each application subscriber to receive the forecast engine's 500 output that is the final decision 590.

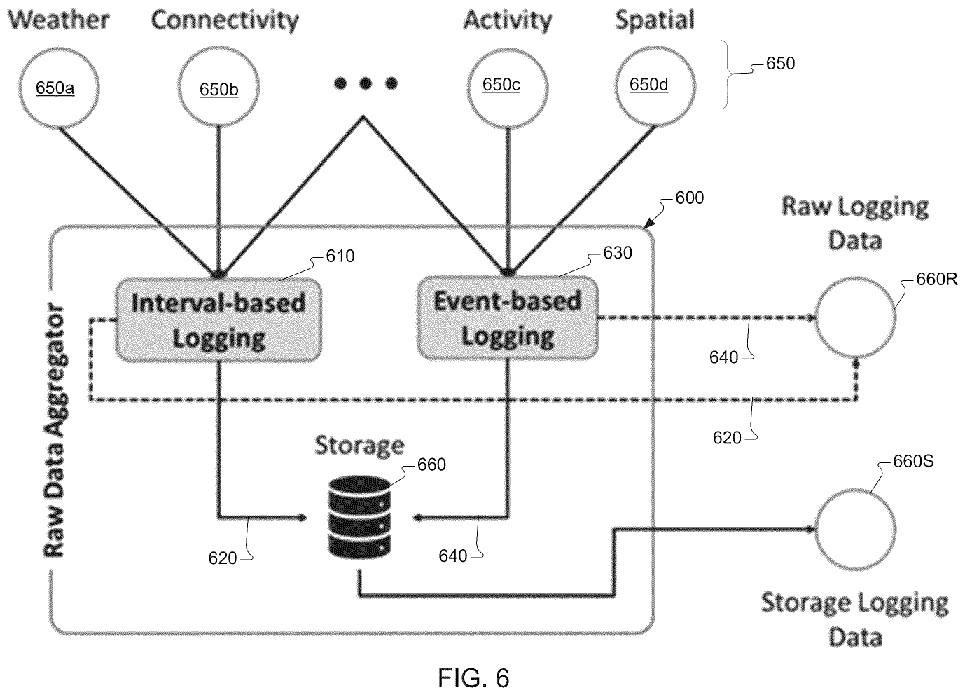

FIG. 6 illustrates a raw data aggregator (RDA) 600, according to embodiments of this disclosure. The embodiment of the RDA 600 shown in FIG. 6 is for illustration only, and other embodiments could be used without departing from the scope of this disclosure. The RDA 600 can be the same as the RDA 510 within the forecast engine 500 of FIG. 5.

The RDA 600 gathers information from multiple sources, such as from smartphones peripherals. The smartphone peripherals include smartphone sensors. The multi-modal data 550 of FIG. 5 includes the weather information 650a, connectivity information 650b, activity information 650c, and spatial information 650d, device power information, mobility status information, biometric information, device settings information, and other information 650 that the RDA 600 gathers. The weather information 650a includes temperature, rain probability, hail probability, etc. The connectivity information 650b includes Wi-Fi scan information and connectivity information, Bluetooth scan information and connectivity information, communication processor information that includes cell tower data. Activity information 650c includes mobility status information, such as information indicating that the user is walking, standing, driving, etc. Spatial information 650d includes GPS information, location timeline, etc. Device power information includes battery charge percentage, status of whether the device is charging, etc. Biometric information includes health data of the user of the device. Device settings information includes audio level, ambient light level, ON/OFF state of airplane mode, etc.

The types of data collected by the RDA system are diverse, but they can be categorized into two main groups by RDA 600. The first group includes interval-based data, which is collected periodically. This interval-based data 610 is a type of data that encompasses Wi-Fi scans, Bluetooth scans, device power measurements, and more. The second group includes event-based data, which is captured whenever a relevant event occurs that triggers a change in the measured values, such as changes in mobility status or device settings.

To achieve this, the RDA 600 utilizes a collection sub-module that implements a hybrid logging mechanism. Interval-based logging sub-module 610 saves interval-based data 620, while event-based logging sub-module 630 captures event-based data 640. By combining these two approaches, the RDA 600 performs comprehensive data collection. The collected data 620 and 640 is stored in a structured repository 660 such as a relational database, enabling its efficient retrieval for prediction inference, and learning purposes. That is, the RDA 600 integrates interval-based logging data 620 and event-based logging data 640 in the repository 660.

The RDA 600 outputs integrated logging data, which can be the same as the integrated logging data 560 of FIG. 5. The storage logging data 660S retrieved from the repository 660 is an example of the integrated logging data output by the RDA 600 for learning purposes. The raw logging data 660R is another example of the integrated logging data output by the RDA 600 for prediction inference purposes. The raw logging data 660R includes both the interval-based data 620 and the event-based data 640.

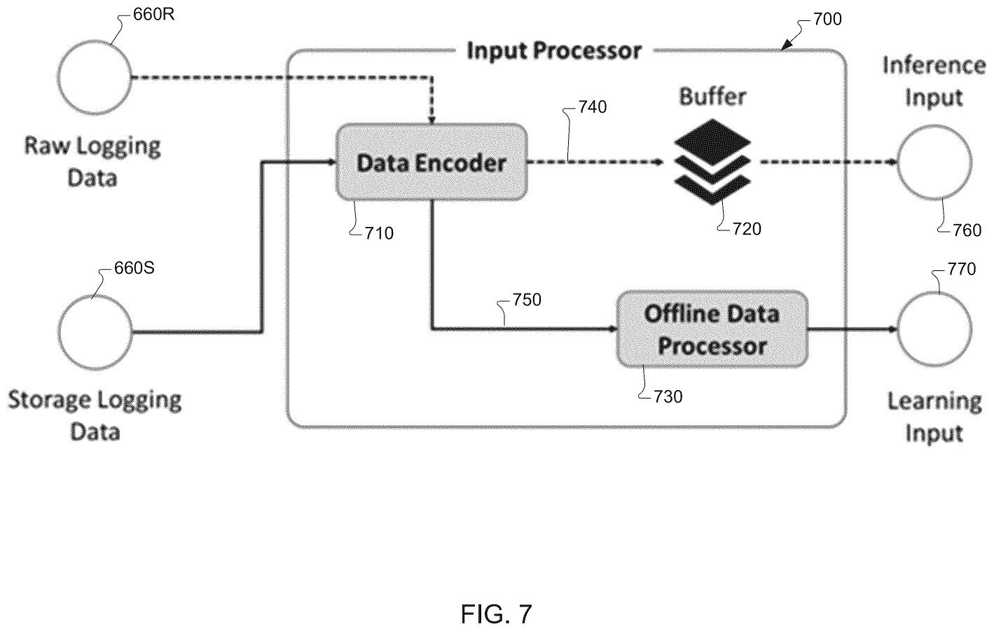

FIG. 7 illustrates an input processor (input processor) 700, according to embodiments of this disclosure. The embodiment of the input processor 700 shown in FIG. 7 is for illustration only, and other embodiments could be used without departing from the scope of this disclosure. The input processor 700 can be the same as the input processor 520 within the forecast engine 500 of FIG. 5.

The input processor 700 retrieves data from the RDA's data repository 660 and processes the retrieved data into a suitable format for input to the central forecasting unit 530 of FIG. 5. The input processor 700 encodes the raw data, prepares data for immediate inference, and prepares data for the AI model's learning and re-learning/updating process. To achieve this, the input processor 700 includes a data encoder 710, a buffer 720, and an offline data processor 730.

The input processor 700 converts the raw logging data 660R into a format of inference input, thereby generating encoded data 740, and converts the storage logging data 660S into a format of learning input, thereby generating encoded data 750. The data encoder 710 encodes the integrated data 660R and 660S using various schemes. Categorical variables are encoded using one-hot encoding, while continuous variables undergo rescaling through min-max normalization. Alternatively, the data encoder 710 can transform these features into fixed-size dense vectors using a neural network.

The input processor 700 maintains a buffer 720 to store the encoded data 740 for each log update. This buffer 720 serves as an accumulation point for real-time data such as the raw logging data 660R, which is then sent into the central forecasting unit 530 to generate immediate forecasts. Inference data 760 is the data output from the buffer 720. In this disclosure, inference data 760 output by the input processor 700 is also referred to as inference input 760 that the central forecast unit 530 receives, and can be the same as the inference input 570a of FIG. 5. This buffer 720 is cleared periodically (for example, every day) to ensure fresh data is collected and processed continuously.

The input processor 700 prepares learning data 770 by performing functions including: retrieve recent data from the database (such as the RDA's repository 660), process it through an encoding step, and then partition the data into training and evaluation sets. These data partitions are subsequently sent into the central forecasting unit 530 to facilitate the learning and re-learning/update process of the AI model. Recent data can be a parameter that defines a sliding window, for example, by default, the past three months of data. As a sliding window, some of the data within a current sliding window of recent data overlaps yesterday's sliding window and overlaps last week's sliding windows. The value of the recent data parameter value is not limited to being three months, and can be a different length of time based on design choice, such as 4 months. To achieve this, the offline data processor 730 receives encoded data 750 generated from three months of storage logging data 660S. The offline data processor 730 partitions the encoded data 750 into training data sets and evaluation data sets, which form the learning data 770. For example, a partition ratio (such as 70/30 or 80/20) can be used by offline data processor 730 to split the encoded integrated logging data 750 such that the from among the three-months of recent data earlier 70% of time is allocated as training data sets and the 30% remainder of time is allocated as evaluation data sets. In this disclosure, learning data 770 output by the input processor 700 is also referred to as learning input 770 that the central forecast unit 530 receives from the buffer 720, and can be the same as the learning input 570b of FIG. 5.

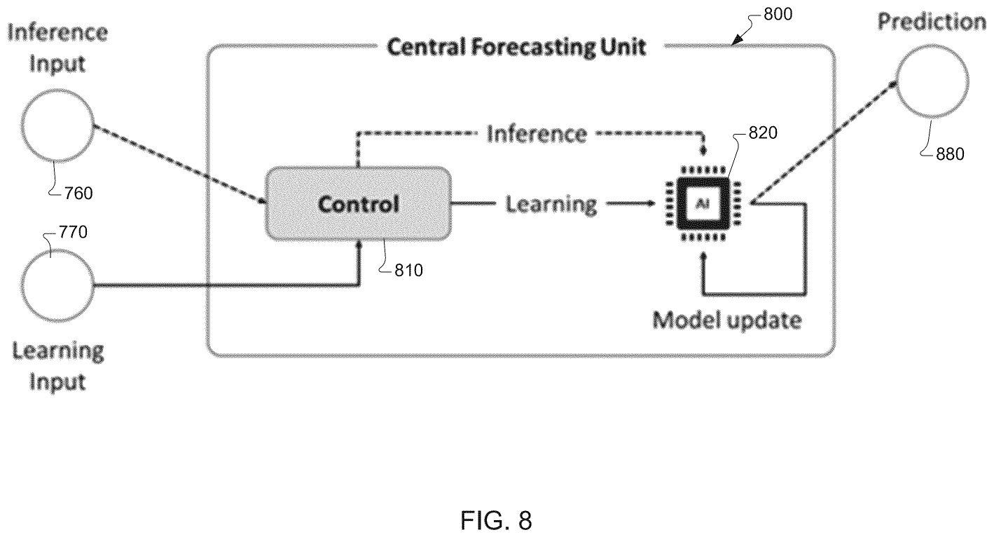

FIG. 8 illustrates a neural central forecasting unit (NCFU) 800, according to embodiments of this disclosure. The embodiment of the NCFU 800 shown in FIG. 8 is for illustration only, and other embodiments could be used without departing from the scope of this disclosure. The NCFU 800 can be the same as the central forecasting unit 530 within the forecast engine 500 of FIG. 5. The prediction 880 can be the same as the prediction 580 output from the central forecasting unit 530 of FIG. 5.

The NCFU 800 includes two primary sub-modules: Control 810 and AI Model 820. The NCFU 800 controls the AI model's execution of real-time inferences based on the provided inference inputs 760 stored in the input processor's input buffer 720. Additionally, NCFU 800 updates the model 820 through a continuous learning process that utilizes the learning input 770 collected and stored within the data storage managed by the input processor 700 of FIG. 7.

The control 810 regulates the data flow to ensure that the appropriate type of data reaches the AI Model 820. For example, the control 810 selects which one, from among the inference input and learning input, to provide as input to the AI model 820. When the control 810 selects the inference input, the control 810 allows the inference input 760 to pass through to AI model 820. For real-time inferences, the AI model 820 receives the inference input, which triggers the AI model 820 to generate raw predictions 880 that the NCFU 800 outputs to the next component in the pipeline (for example, post processor 540 of FIG. 5).

Alternatively, when the control 810 selects the learning input to update the AI model 820, the control 810 allows the learning input 770 to pass through to the AI model 820. The central forecasting unit trains the AI model 820 to perform a prediction-generating process before the control 810 is allowed to select the inference input. When initially operating the forecast engine, the control 810 initially selects the learning input to enable a learning process of the AI model 820 until training of the AI model is completed. When updating the model, the control 810 regulates such that the learning input 770 is provided as input to the AI model 820 instead of the inference input, triggering the training process. The AI model 820 includes an architecture, which is the design of the model, and the AI model 820 includes weights of each connection. The training process establishes weights, and the later re-learning process updates existing weights to new weight values.

By utilizing this learning input, the AI model 820 trains and evaluates a new AI model's performance. If the new model demonstrates satisfactory results, then the new model replaces the existing one.

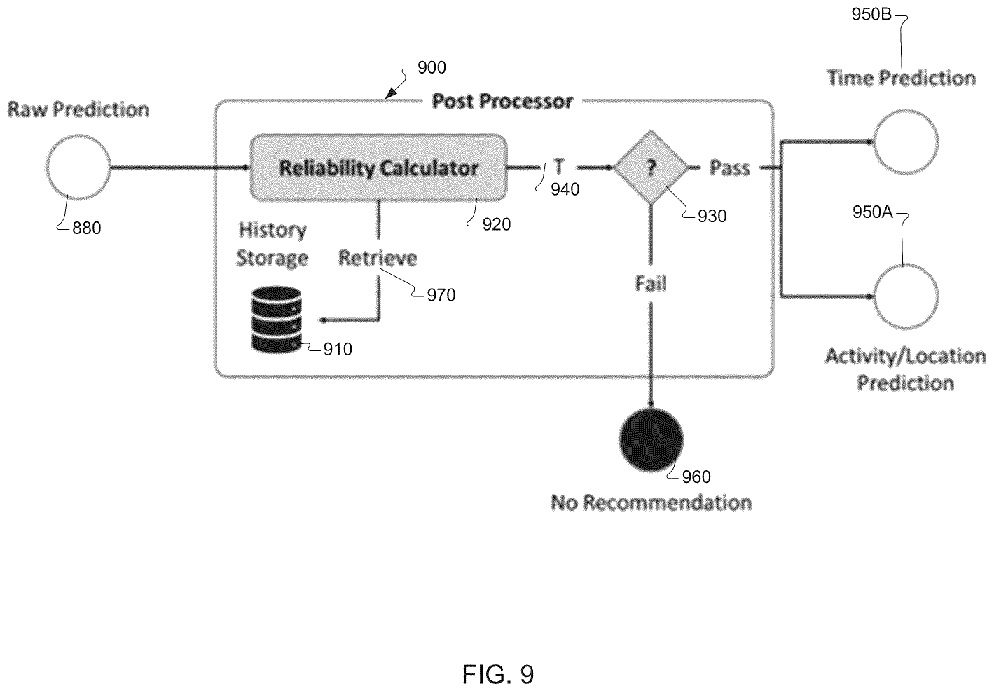

FIG. 9 illustrates a post processor 900, according to embodiments of this disclosure. The embodiment of the post processor 900 shown in FIG. 9 is for illustration only, and other embodiments could be used without departing from the scope of this disclosure. The post processor 900 can be the same as the post processor 540 within the forecast engine 500 of FIG. 5. That is, post processor 900 can be the final component within the pipeline of the forecast engine.

The post processor 900 includes a repository 910 that stores ground truth and historical predictions, a reliability calculator 920 sub-module, and a reliability threshold 930. One purpose of the post processor 900 is to utilize the raw prediction 880, which was generated by the NCFU 800, together with the historical predictions and ground truth stored in a repository 910, to calculate a probability value 940 representing the reliability of the current raw prediction 880. By doing so, the smartphone 410 and its applications 430 of FIG. 4 can confidently utilize the final predictions 950a-950b (950) for further usage. The probability value 940 can be referred to as a confidence level. In cases where the probability value 940 falls below a reliability threshold (i.e., fails to satisfy a reliability threshold condition), the prediction 880 will be discarded 960. However, if the probability value 940 meets the required or desired criteria (i.e., satisfies a reliability threshold condition), the current prediction 880 is deemed as a validated, final predication 950 that will be utilized.

The reliability calculator 920 retrieves a historical prediction and ground truth from storage repository 910 to assess the performance of the model in the past, for example, by querying 970 the historical predictions for a match to the raw prediction 880. By using metrics such as accuracy, precision, recall, or F1-score for categorical predictions, the post processor 900 determines if the current prediction 880 meets the desired level of reliability. A reliability threshold 930 is set to make this decision, thereby ensuring only accurate predictions are output as recommendations. Similarly, for regression predictions, the post processor 900 uses metrics like mean square error (MSE) to evaluate the quality of the predictions 880. The reliability thresholds 930 used for determining the final prediction are regularly reevaluated based on the amount of newly acquired predictions and corresponding ground truths in the repository 910.

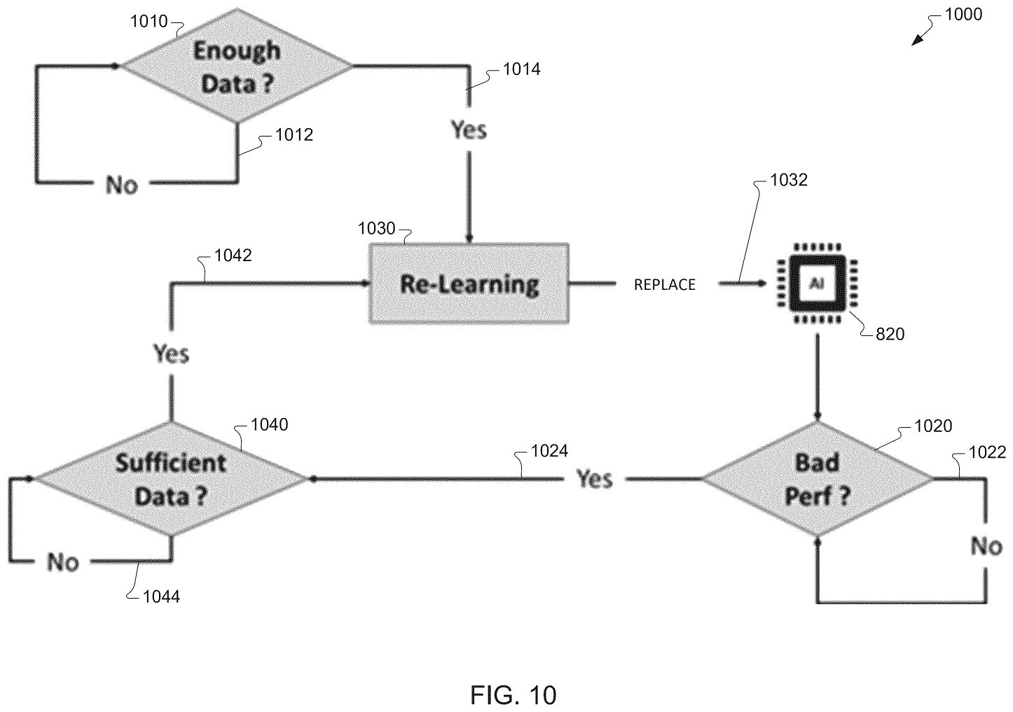

FIGS. 10, 11, and 12 illustrate various processes 1000, 1100, and 1200 implemented by the central forecasting unit 530, according to embodiments of this disclosure. For ease of explanation, the processes 1000, 1100, and 1200 will be described as being implemented in the UE 116 of FIG. 3. However, the processes 1000, 1100, and 1200 could be implemented in any other suitable device.

FIG. 10 illustrates a process 1000 for triggering a re-learning of an AI model, according to embodiments of this disclosure. The embodiment of the process 1000 for triggering the re-learning of the AI model shown in FIG. 10 is for illustration only. Other embodiments of the process 1000 for triggering a re-learning of the AI model 820 could be used without departing from the scope of this disclosure. For ease of explanation, the process 1000 for triggering a re-learning of the AI model will be described as being implemented in the control sub-module 810 of FIG. 8.

In some embodiments, there are two independent conditions 1010 and 1020 that trigger an adaptive re-learning 1030 of the AI model 820. The first condition 1010 is based on the quantity of newly available data, which triggers periodically. The second condition 1020 is based on the performance of the current model. If the performance of the current AI model 820 falls below an acceptable-performance threshold (for example, 90% accuracy) and there is a sufficient amount of data (for example, accumulated in the storage logging data 660S), then the re-learning process 1030 initiates. In other embodiments, there can be more or fewer dependent or independent conditions that trigger a re-learning of the AI model.

In the process 1000, the control 810 receives, from offline data processor 730, the partitioned, encoded integrated logging data 750 that includes training sets, evaluation sets, and a testing data set. The testing data set is a third data set that includes testing window of time later following the recent data window. This example describe an example testing window parameter value that spans one week, but a designer may choose a different testing window parameter value, such as two weeks or 10 days.

At the block of the first condition 1010, the processor(s) 340 uses the control 810 to determine whether the received and stored information (stored logging data 660S) within the RDA's 600 data repository 660 satisfies a quantity condition for a test data set. For example, quantity threshold can be a sum of on the recent data parameter value and the testing window, such as three months plus one week. The control 810 determines 1012 that quantity threshold condition is not satisfied if the RDA's data repository 660 batches less than the quantity threshold of data (i.e., three months plus one week of data), which means there is not enough data available to perform a re-learning process.

Alternatively, in response to a determination 1014 that the information received into the RDA's data repository 660 satisfies the quantity condition, the control 810 determines whether both the first and second conditions 1010 and 1020 (i.e., Quantity & Bad-Performance Conditions) are satisfied? If only one among the two conditions 1010 and 1020 is satisfied, then the control 810 selects the inference input as the selected format of the converted information and continues to use the current AI model 820. For example, at the block of the second condition 1020, the processor(s) 340 uses the control 810 to determine 1022 that a performance (e.g., accuracy) of the neural model 820 greater than or equal to an acceptable-performance threshold does not satisfy the second condition (bad-performance condition) 1020. In other words, an acceptable-performance threshold condition is satisfied based on the determination 1022. The control 810 selects the interference input as the selected format based on the determination 1022 that the bad-performance condition 1020 is not satisfied.

Also, at the block of the second condition 1020, the control 810 determines 1024 that a performance of the neural model 820 less than the acceptable-performance threshold satisfies the bad-performance condition 1020 (in other words, the acceptable-performance threshold condition is not satisfied).

At block 1040, in response to satisfaction of the bad-performance condition 1020, the control 810 determines whether both the first and second conditions 1010 and 1020 are satisfied, and if “yes” 1042, then the control 810 selects the learning input as the selected format of the converted information, thereby triggering the re-learning process 1030 to retrain and reevaluate the neural AI model 820. If only one among the two conditions 1010 and 1020 is satisfied, then the control 810 determines 1044 that there is insufficient data available to initiate a re-learning process, and selects the inference input as the selected format of the converted information and continues to use the current AI model 820.

The re-learning process 1030 includes training an AI machine learning model, and updating the weights in the model's architecture. The re-learning process 1030 triggers a replacement 1032 to replace the current AI model 820 with a retrained AI model. That is, the replacement 1032 includes replacing the current neural model with the retrained neural model, based on a determination that a performance of the retrained neural model satisfies the acceptable-performance threshold condition.

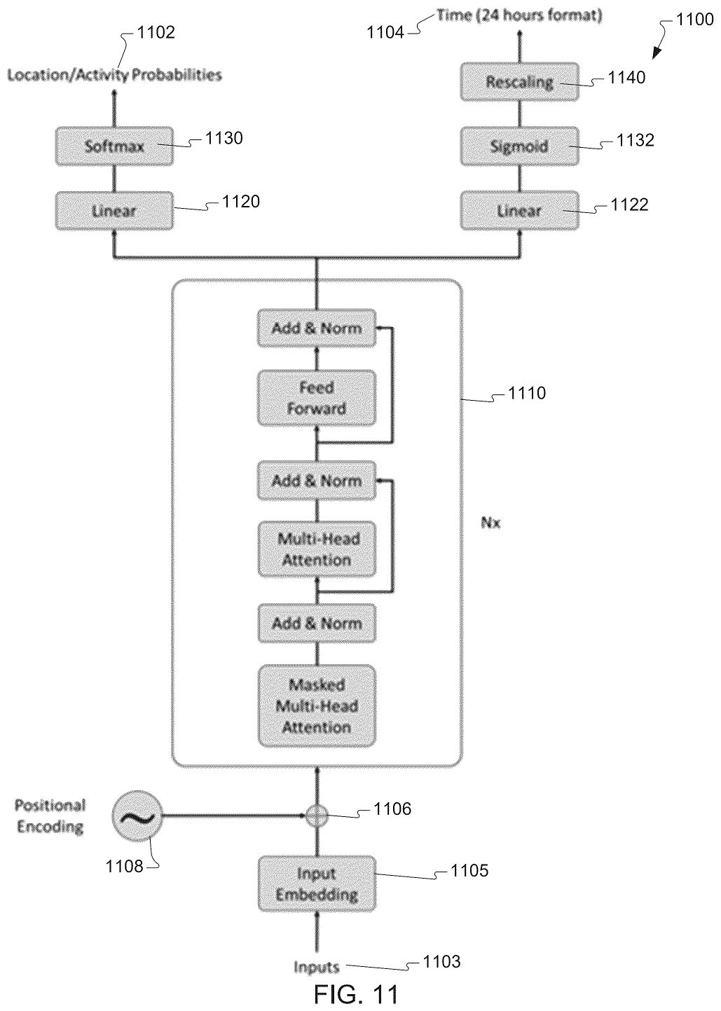

FIG. 11 illustrates a process 1100 of generating raw predictions of probable future contexts 1102 and 1104 for the user using an AI model that is implemented using transformer architecture 1110 according to embodiments of this disclosure. More particularly, FIG. 11 shows that the AI model 820 is implemented using transformer architecture 1110, according to embodiments of this disclosure. The embodiment of the AI model 820 and transformer architecture 1110 shown in FIG. 11 are for illustration only, and other embodiments could be used without departing from the scope of this disclosure. These predictions 1102 and 1104 can be the same as the raw predictions 880 of FIG. 8.

The AI Model 820 can be implemented utilizing diverse techniques, ranging from approaches like Support Vector Machines and Random Forests to cutting-edge models such as Deep Neural Networks (e.g., Convolutional Neural Network, Transformer, or Graph Neural Network architectures). Various learning paradigms can also be employed, including Supervised Learning and Reinforcement Learning. In the case of Supervised Learning, the ground truth data collected post-predictions serves as direct training material for the model. Conversely, when employing Reinforcement Learning, a reward function is utilized to provide an appropriate reward based on the model's predictions or provide an appropriate punishment if the model performs wrongly, thereby updating the model accordingly. The transformer architecture 1110 is one of multiple different types of architecture that a designer can select for the AI model 820 within the neural central forecasting unit 800 of FIG. 8.

Given that in example in FIG. 11, the transformer architecture 1110 is used to implement the AI model, this task can be analogized to the next-word-prediction task for which generative pre-training transformer (GPT) models are employed. Instead of predicting the subsequent word in a sentence, the transformer architecture 1110 can anticipate the next location 1102 in the user's movement trajectory or the next event 1102 in the user's activity trajectory along with the corresponding timestamp 1104. That is, the NCPU 800 trains the AI model (including the transformer architecture 1110) to perform a prediction-generation process based on the best available trajectory data to forecast future location/activity events to forecast complete trajectories.

As a comparison, a GPT operates based on a token. When the GPT has a series of tokens, then the GPT is triggered to generate a new token. For example, the GPT has a sentence (i.e., a series of words/tokens) the serves as best available trajectory data to perform forecasting; when a user input asks the GPT to generate a new word from the words within the sentence, then the GPT uses the sentence to generate a new word/token to be next in the sentence. Analogously the transformer architecture 1110 has a series of contexts (for example, spatial context) that serves as available trajectory data to be utilized for forecasting a next future context (for example, next GPS location as future spatial context)).

By using the trajectory up until the previous prediction/ground truth, such trajectory can be feedback into the network to forecast the upcoming event 1102 or the entire trajectory. As an example of available spatial context trajectory data: the user is at home at 7:00 AM; the user is at the user's workplace at 8:00 AM; the user is at a restaurant to eat lunch at 12:00 PM; the user got off from work and is at the gym at 4:00 PM; and the user is back at home at 6:00 PM. The AI model 820 can learn a spatial trajectory pattern associated with this particular user, such that if the user is at home at 7:00 AM, then the AI model 820 can generate a prediction of the future spatial context is that the user's next location might be at the user's workplace. As another example, the AI model can if the user is at home at 7:00 AM, then the AI model 820 can generate a prediction of the future spatial context is that the user's next location might be somewhere else, based on the particular user's schedule. The AI model 820 is not limited to predicting the user's next location, but can also predict a series of multiple locations, which is analogous to a GPT predicting a next sentence based on a paragraph as the available trajectory data.

The process 1100 includes receiving inputs 1103 the AI model 820, such as geographical location(s) or location identifiers. For example, location identifiers 1, 2, and 3 can be encoded values that correspond to the terms “home,” “workplace,” and “gym,” respectively. The process 1100 can include input embedding, which generates a token 1105 or tokenized form the received input 1103. The process 1100 includes element-wise vector summing 1106 to combine positional encoding 1108 outputs with the token 1105. The output from the element-wise vector summing 1106 is input to the transformer architecture 1110.

The transformer architecture 1110 includes a masked multi-head attention, add & normalize, a multi-head attention, another add & normalize, a feed forward, and another add & normalize. The outputs from the transformer architecture 1110 are connected to a first linear layer 1120 corresponding to location/activity context and a second linear layer 1122 corresponding to temporal context. The process 1100 applies a softmax function 1130 to outputs from the first linear layer 1120, thereby generating the prediction 1102 of the user's next location.

In some embodiments, the second linear layer 1122 includes only one neuron. The process 1100 applies a sigmoid thresholding function 1132 to the outputs from the second linear layer 1122, and applies a rescaling 1140 to the outputs from the sigmoid thresholding function 1132. In some embodiments, rescaling 1140 rescales into a 24-hour per day scale so that the prediction 1104 of the time at which the user might be at the next location/activity (1102) is output in 24 hours format.

In this example of the process 1100, the transformer architecture 1110 performs time prediction. However, in other embodiments, In some embodiments, the transformer architecture 1110 does not perform time prediction, and instead, a time averaging function is used. This means that each location that has a location ID, and that the times at which the user is located at the respective locations having each location ID. If the transformer architecture 1110 predicts that the next location ID is X, then the time averaging function outputs an average of the corresponding times.

Although FIG. 11 describes a prediction-generation process 1100, this disclosure also provides methods to update the AI model because user behavior can change over time. For example, the user's behavior in January may be different from behavior in February. So, when training the AI model, this disclosure assigns more weight to more recent data.

In order to quickly adapt the AI model to the user behavior pattern in case there is a change in the user routine and behavior, recent data samples shall be assigned slightly more weights compared to older data samples in the training process. Assume the weight coefficient is α, n is the number of data samples, and i is the index where i=0 is the oldest index and i=n−1 is the newest index. The sum of all the weight coefficients is 1, as expressed in Equation 1.

$${\sum }_{i = 0}^{n - 1} {α}_{i} = 1 \qquad ( 1 )$$

The initial value for the first coefficient can be calculated using Equation 2.

$${α}_{0} = \frac{2}{n ( n + 1 )} \qquad ( 2 )$$

The subsequent coefficient can be calculated using the Equation 3.

$${α}_{i} = {α}_{0} ⋆ ( i + 1 ) where i ∈ [ 1 , n ) \qquad ( 3 )$$

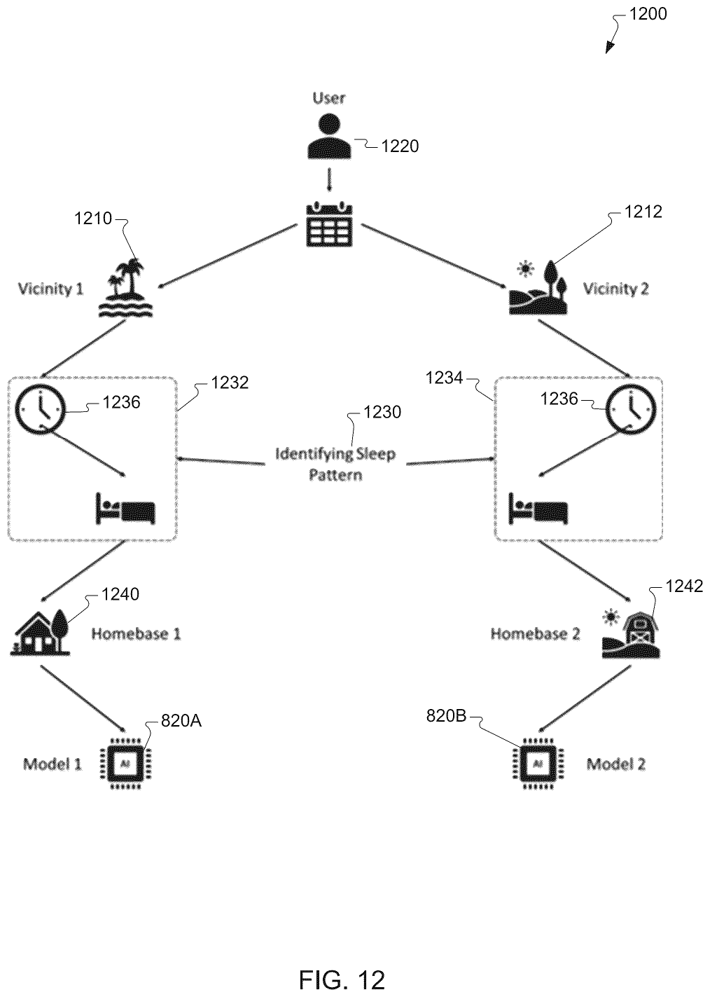

FIG. 12 illustrates a process 1200 for determining a number of home-bases for the NCFU 800, according to embodiments of this disclosure. The embodiment of the process 1200 shown in FIG. 12 is for illustration only. Other embodiments of the process 1200 could be used without departing from the scope of this disclosure. For ease of explanation, the process 1200 for determining a number of home-bases for the NCFU 800 will be described as being implemented in the control sub-module 810 of FIG. 8. The user 1220 of FIG. 12 can be the same as the user 420 of FIG. 4.

Some users may have multiple living arrangements throughout the year. For instance, a user may reside in one geographic region (Vicinity 1) 1210 for a portion of the year and in another geographic region (Vicinity 2) 1212 for the remainder of the year. For example, the user 1220 can reside in Fort Lauderdale during Winter and Autumn and reside in Minneapolis during Spring and Summer.

To determine the user's primary residence in each geographic region, the NCFU 800 can monitor 1230 the user's sleep patterns 1232 and 1234 by tracking the user's location during times 1236 when the user is most likely to be asleep. By analyzing the user's frequent presence in a particular location during this time frame 1236, the NCFU 800 can identify that particular location as the user's home base 1240 and 1242. In cases with multiple home bases, the NCFU 800 can deploy multiple AI models 820a-820b accordingly. When the user is present at a specific home base, the NCFU 800 will activate the corresponding AI model.

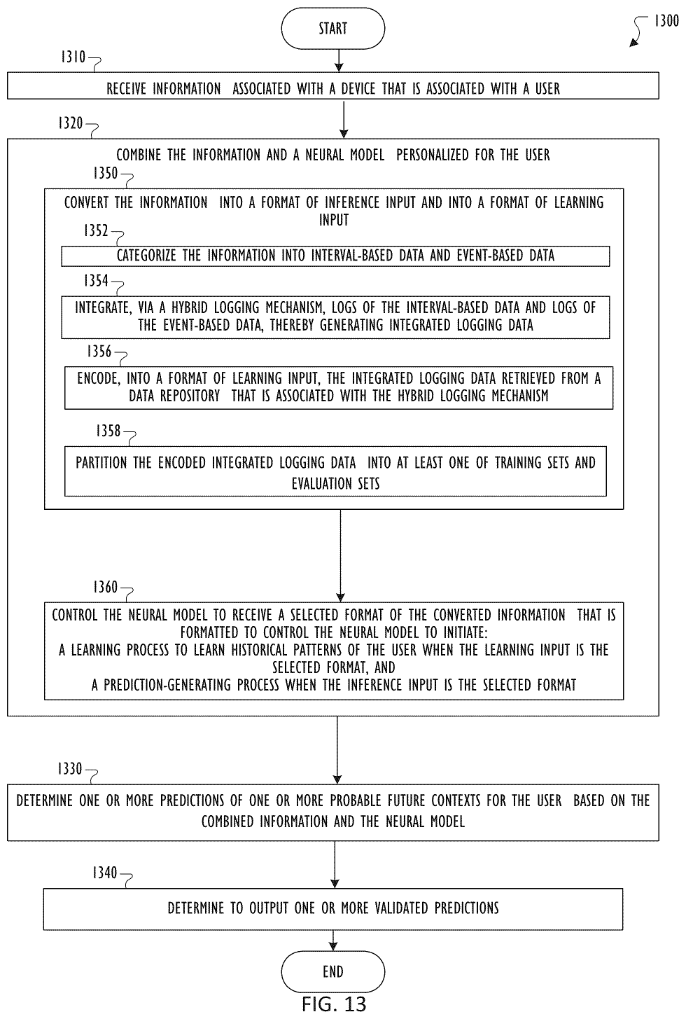

FIG. 13 illustrates a method 1300 for context-aware location and activity prediction for smartphone users, according to embodiments of this disclosure. The embodiment of the method 1300 shown in FIG. 13 is for illustration only. Other embodiments of the process 1200 could be used without departing from the scope of this disclosure. For ease of explanation, the method 1300 will be described as being implemented in the UE 116 of FIG. 3, wherein the processor(s) 340 execute the forecast engine 500 of FIG. 5. However, the method 1300 could be implemented in any other suitable device.

At block 1310, the processor(s) 340 receive information 550, 650 associated with a device 116 that is associated with a user 420, 1220. For example, the raw data aggregator 510 receives multi-modal data 550 such the information 650 that the RDA 600 gathers from multiple sources.

At block 1320, the processor(s) 340 combines the information 550, 650 and a neural model 820 personalized for the user 420. To combine the information 550, 650 and the neural model 820 personalized for the user, block 1320 includes blocks 1350 and 1360, as described more particularly below.

At block 1330, the processor(s) 340 determines one or more predictions of one or more probable future contexts for the user based on the combined information and the neural model. The one or more predictions can be raw predictions 880 or validated predictions 950. The one or more probable future contexts include a spatial context, a temporal context, or a behavioral context.

At block 1340, the processor(s) 340 determines to output one or more validated predictions. That is, a validation process is applied to the one or more raw predictions 880 to generate or permit output of one or more validated prediction 950 that correspond to a sufficiently high probability of reliability. The procedure of block 1340 is described more particularly in FIG. 15.

Some embodiments include blocks 1350-1360 to combine the information and the neural model. At block 1350, the processor(s) 340 converts the information 550, 650 into a format of inference input and into a format of learning input. For example, the data encoder 710 converts the raw logging data 660R into the format of the interference input 760, and converts the storage logging data 660S into the format of the learning input 770. To convert the information 550, 650 into the two formats, block 1350 includes blocks 1352 through 1358, as described more particularly below.

At block 1360, the processor(s) 340 control the neural model 820 to receive a selected format of the converted information that is formatted to control the neural model to initiate: a learning process to learn historical patterns of the user when the learning input 770 is the selected format, and a prediction-generating process when the inference input 760 is the selected format. The converted information includes the inference input 760 and the learning input 770. The control sub-module 810 controls the AI-model 820 by selecting the format of the converted information.

Some embodiments include blocks 1352-1358 to control the neural model 820 to receive the selected format of the converted information. At block 1352, the processor(s) 340 categorize the information into interval-based data and event-based data. For example, the interval-based logging sub-module 610 generates interval-based data 620 logs based on the information 650 that the UE receives periodically, such as weather and connectivity information 660a-650b. For example, the event-based logging sub-module 630 generates event-based data 640 logs based on the information 650 that the UE receives in response to an event, such as generated in response to a UE travel event based on change of GPS location, UE motion event based on motion sensor data, or battery status event based on whether the UE is connected to a charger, whether the battery is currently charging, whether the battery charge percentage falls below a low-power threshold.

At block 1354, the processor(s) 340 integrate via a hybrid logging mechanism, logs of the interval-based data and logs of the event-based data, thereby generating integrated logging data. For example, the RDA 600 can be the hybrid logging mechanism. At block 1356, the processor(s) 340 encode, into a format of learning input, the integrated logging data (such as stored logging data 660S) retrieved from a data repository 660 that is associated with the hybrid logging mechanism. At block 1358, the processor(s) 340, using the offline data processor 730, partitions the encoded integrated logging data 750 into training sets, evaluation sets, or both. The learning data 770 includes training data sets and evaluation data sets. The procedure performed at block 1358 can include the process 1000 of FIG. 10.

Although the method 1300 is described as being implemented within the UE 116, in another embodiment, the method 1300 could be implemented by cloud-based server (such as at the gNB 102) that executes a forecast engine personalized for each user account. The server can establish a network connection to the UE, receive information associated with the UE, and associate the received information to a user account being used on the UE. The server provide final predictions to the UE and UE's apps.

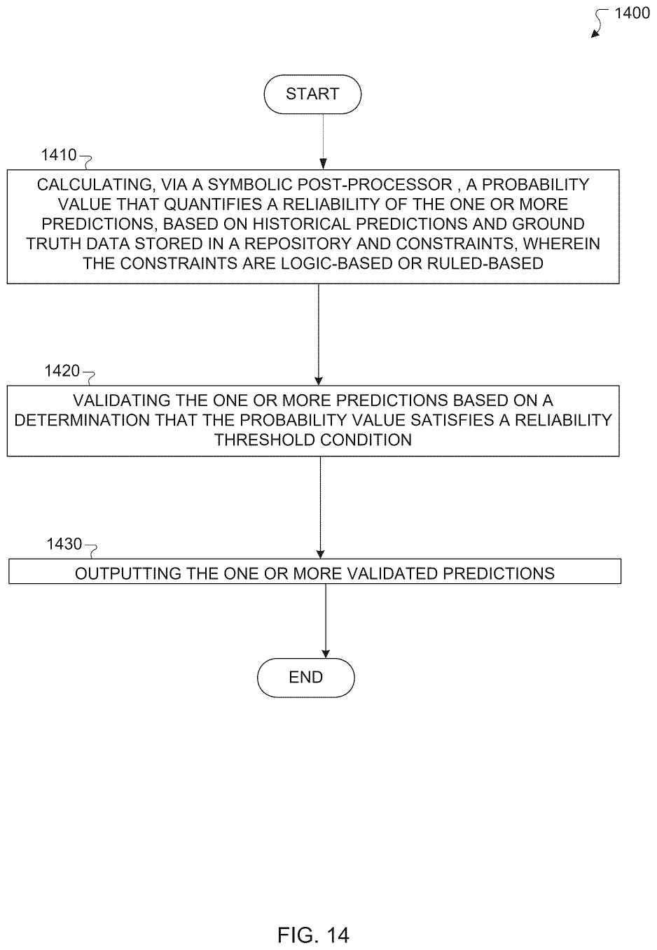

FIG. 14 illustrates a method 1400 for partitioning the encoded integrated logging data into at least one of training sets and evaluation sets, according to embodiments of this disclosure. The method 1400 can be the procedure performed at block 1340 of FIG. 13.

At block 1410, the processor(s) 340 calculates, via a symbolic post-processor, a probability value that quantifies a reliability of the one or more predictions, based on historical predictions and ground truth data stored in a repository and constraints. The constraints are logic-based or rule-based.

At block 1420, the processor(s) 340 validates the one or more predictions based on a determination that the probability value satisfies a reliability threshold condition.

At block 1430, the processor(s) 340 outputs the one or more validated predictions.

Although FIGS. 13 and 14 together illustrate an example method 1300 for context-aware location and activity prediction for smartphone users, various changes may be made to FIGS. 13 and 14. For example, while shown as a series of steps, various steps in FIGS. 13 and 14 could overlap, occur in parallel, occur in a different order, or occur any number of times.

The above flowchart illustrates an example method that can be implemented in accordance with the principles of the present disclosure and various changes could be made to the method illustrated in the flowchart herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method implemented by at least one processor, the method comprising:
receiving information associated with a device that is associated with a user;
combining the information and a neural model personalized for the user; and
determining one or more predictions of one or more probable future contexts for the user based on the combined information and the neural model, the one or more probable future contexts including at least one of: a spatial context, a temporal context, or a behavioral context.

2. The method of claim 1, wherein combining the information and the neural model further comprises:
converting the information into a format of inference input and into a format of learning input; and
controlling the neural model to receive a selected format of the converted information that is formatted to control the neural model to initiate:
a learning process to learn historical patterns of the user when the learning input is the selected format, and
a prediction-generating process when the inference input is the selected format.

3. The method of claim 1, further comprising:
categorizing the information into interval-based data and event-based data; and
integrating, via a hybrid logging mechanism, logs of the interval-based data and logs of the event-based data, thereby generating integrated logging data.

4. The method of claim 3, further comprising:
encoding, into a format of learning input, the integrated logging data retrieved from a data repository that is associated with the hybrid logging mechanism; and
partitioning the encoded integrated logging data into at least one of training sets and evaluation sets.

5. The method of claim 1, further comprising:
triggering an adaptive re-learning process to retrain and reevaluate the neural model, based on a determination that a performance of the neural model fails to satisfy an acceptable-performance threshold condition and a determination that the information received into a data repository satisfies a quantity condition.

6. The method of claim 5, further comprising:
replacing the neural model with the retrained neural model, based on a determination that a performance of the retrained neural model satisfies the acceptable-performance threshold condition.

7. The method of claim 1, further comprising:
calculating, via a symbolic post-processor, a probability value that quantifies a reliability of the one or more predictions, based on historical predictions and ground truth data stored in a repository and constraints, wherein the constraints are logic-based or ruled-based;
validating the one or more predictions based on a determination that the probability value satisfies a reliability threshold condition; and
outputting the one or more validated predictions.

8. A system comprising:
at least one processor configured to:
receive information associated with an electronic device that is associated with a user;
combine the information and a neural model personalized for the user; and
determine one or more predictions of one or more probable future contexts for the user based on the combined information and the neural model, the one or more probable future contexts including at least one of: a spatial context, a temporal context, or a behavioral context; and
at least one sensor located within the electronic device and configured to generate sensor data associated with the electronic device, wherein the information includes the sensor data.

9. The system of claim 8, wherein to combine the information and the neural model, the at least one processor is further configured to:
convert the information into a format of inference input and into a format of learning input; and
control the neural model to receive a selected format of the converted information that is formatted to control the neural model to initiate:
a learning process to learn historical patterns of the user when the learning input is the selected format, and
a prediction-generating process when the inference input is the selected format.

10. The system of claim 8, wherein the at least one processor is further configured to:
categorize the information into interval-based data and event-based data; and
integrate, via a hybrid logging mechanism, logs of the interval-based data and logs of the event-based data, thereby generating integrated logging data.

11. The system of claim 10, wherein the at least one processor is further configured to:
encode, into a format of learning input, the integrated logging data retrieved from a data repository that is associated with the hybrid logging mechanism; and
partition the encoded integrated logging data into at least one of training sets and evaluation sets.

12. The system of claim 8, wherein the at least one processor is further configured to:
trigger an adaptive re-learning process to retrain and reevaluate the neural model, based on a determination that a performance of the neural model fails to satisfy an acceptable-performance threshold condition and a determination that the information received into a data repository satisfies a quantity condition.

13. The system of claim 12, wherein the at least one processor is further configured to:
replace the neural model with the retrained neural model, based on a determination that a performance of the retrained neural model satisfies the acceptable-performance threshold condition.

14. The system of claim 8, wherein the at least one processor is further configured to:
calculate, via a symbolic post-processor, a probability value that quantifies a reliability of the one or more predictions, based on historical predictions and ground truth data stored in a repository and constraints, wherein the constraints are logic-based or ruled-based;
validating the one or more predictions based on a determination that the probability value satisfies a reliability threshold condition; and
outputting the one or more validated predictions.

15. The system of claim 8, wherein the electronic device includes at least one processor.

16. A non-transitory computer readable medium embodying a computer program, the computer program comprising computer readable program code that, when executed by a processor of an electronic device, causes the processor to:
receive information associated with the electronic device that is associated with a user;
combine the information and a neural model personalized for the user; and
determine one or more predictions of one or more probable future contexts for the user based on the combined information and the neural model, the one or more probable future contexts including at least one of: a spatial context, a temporal context, or a behavioral context.

17. The non-transitory computer readable medium of claim 16, wherein the program code that, when executed by the processor, causes the processor to combine the information and the neural model further comprises program code that when executed causes the processor to:
convert the information into a format of inference input and into a format of learning input; and
control the neural model to receive a selected format of the converted information that is formatted to control the neural model to initiate:
a learning process to learn historical patterns of the user when the learning input is the selected format, and
a prediction-generating process when the inference input is the selected format.

18. The non-transitory computer readable medium of claim 16, further comprising program code that, when executed by the processor, causes the processor to:
categorize the information into interval-based data and event-based data; and
integrate, via a hybrid logging mechanism, logs of the interval-based data and logs of the event-based data, thereby generating integrated logging data.

19. The non-transitory computer readable medium of claim 18, further comprising program code that, when executed by the processor, causes the processor to:
encode, into a format of learning input, the integrated logging data retrieved from a data repository that is associated with the hybrid logging mechanism; and
partition the encoded integrated logging data into at least one of training sets and evaluation sets.

20. The non-transitory computer readable medium of claim 16, further comprising program code that, when executed by the processor, causes the processor to:
trigger an adaptive re-learning process to retrain and reevaluate the neural model, based on a determination that a performance of the neural model fails to satisfy an acceptable-performance threshold condition and a determination that the information received into a data repository satisfies a quantity condition.
